(19) United States
(12) Patent Application Publication
(10) Pub. No.: US 2004/0103046 A1
(43) Pub. Date: May 27, 2004

(54) Handheld ERP system

(75) Inventors: Daniel W. Christoph, Milwaukee, WI (US); James R. McClellan, Menomonee Falls, WI (US)

Correspondence Address: Andrew S. McConnell, Boyle Fredrickson Newholm Stein & Gratz, S.C., 250 Plaza, Suite 1030, 250 East Wisconsin Avenue, Milwaukee, WI, 53202, US

(73) Assignee: Christoph Fryer Jaskie, Inc.

(21) Appl. No.: 10/265,884

(22) Filed: Oct. 7, 2002

Related U.S. Application Data
(60) Provisional application No. 60/327,636, filed on Oct. 8, 2001.

(51) Int. Cl. G06F 17/60

(52) U.S. Cl. 705/28

(57) ABSTRACT

A system for accurately monitoring and planning for the distribution of the resources of a business is provided. The system includes a data processing unit running an enterprise resource planning (ERP) program that is controlled by an administrator and that stores various types of information regarding the resources utilized and produced by the business. Workers using handheld computing devices can access the data processing unit and download requests for information from the program necessary to update the information stored on the data processing unit regarding the resources of the business and used by the program. The workers then take the handheld devices out onto the various areas of the facility for the business in order to locate and enter the requested information into the handheld devices. The information entered onto the handheld devices by the workers can then be uploaded either directly or indirectly to the data processing unit in order for use by the program in updating the resource information for the business.

### CROSS REFERENCE TO RELATED APPLICATIONS

This application claims priority under 35 U.S.C. §119(e) to U.S. Provisional Patent Application No. 60/327,636, filed Oct. 8, 2001.

### FIELD OF THE INVENTION

The present invention relates to enterprise resource planning (ERP) systems used in monitoring the consumption and resupply of resources utilized in warehousing and manufacturing businesses, and more specifically to an ERP system in which data utilized within the system is recorded and transferred electronically.

### BACKGROUND OF THE INVENTION

In order to effectively operate a manufacturing or warehousing business operation, it is necessary to keep track of the resources or materials handled by the business operation at each stage of the manufacturing or warehousing/shipping process. To do so, enterprise resource planning (ERP) systems have been developed that allow workers to input information regarding the resources available to the business, and materials utilized and produced by the business using these resources into a central processing computer that stores and updates this information as it is entered. The areas in which ERP systems have provided the most benefit in keeping track of the resources used by a business are inventory control, shipping orders or finished products, receiving raw materials, shipping products to an outside processor and receiving products from an outside processor, among others. By allowing businesses to enter data regarding these facets of the business, and storing and updating the information regarding these areas as new data is entered, ERP systems provide reliable information about the resources utilized in the day-to-day operation of a manufacturing or warehousing operation so that it is possible to identify what, if any, parts of the business are using resources ineffectively.

However, while ERP systems are capable of providing up-to-date information about the materials utilized in the business on demand, the up-to-date information supplied by the ERP system is only as accurate as the information that is entered into the ERP system by the workers. In current applications of ERP systems, workers walk through the business facility and write down information about the materials and/or products available for use by the business. In most cases, the workers use clipboards which hold data sheets that include spaces for the information to be written down for use in the ERP system. As the workers walk around the facility, they write down the relevant data on the sheets regarding the available inventory, works in process, shipments, both incoming and outgoing, and other items for which data is required by the ERP system. The workers then take the clipboards back to a central processing station and the hand-written data is entered into the ERP system. The information can be entered by the person who wrote the data down on the clipboard, or by another individual who is tasked specifically with the data entry. Also, each sheet contains numerous spots for entry of the data onto the sheets such that once all of the newly collected data is entered from a particular sheet, another worker can utilize the same sheet to collect more information for use in the ERP system.

However, by using this process for data collection, the information supplied to the ERP system can be highly inaccurate. More specifically, due to a number of factors, e.g., variations in the handwriting of different workers, misunderstandings of the workers regarding the proper placement of information on the sheet, writing down incorrect information (e.g., transposing numbers in a specific data field), or other possible errors that can be made using the sheets, there are a variety of ways in which incorrect information can be supplied and inputted into the ERP system.

Furthermore, an ERP system which relies on sheets containing the hand-written information also suffers from significant lag time caused by the delay in getting this information into the ERP system. Because the only times when data can be inputted into the ERP system, whether correct or incorrect, is when the worker brings back a sheet including the information written down by the worker, the ERP system cannot be updated quickly as it takes time for the worker to walk through the facility, write down the information, and physically convey the information back to the ERP system. There is also time required to manually enter the information into the ERP system from the sheets one at a time that further delays the availability of the information to and from the ERP system. Also, because of the problems discussed above regarding the correctness of the information on the sheets, when a problem is discovered it also takes time to erase the incorrect information entered into the ERP system which can result in inaccurate or old information being provided to a worker receiving information from the system on a sheet.

Therefore, it is desirable to develop an ERP system in which data can be collected by workers in a much more efficient and accurate manner to increase the overall speed and efficiency of the ERP system. It is also desirable to develop an ERP system in which the more accurate data can be collected by the workers and transferred directly to the ERP system in a much faster manner in order for the ERP system to provide updated information on the operation of the business in virtually a real time manner.

### SUMMARY OF THE INVENTION

It is an object of the present invention to provide an improved ERP system that greatly reduces the possibility for entering incorrect information into the ERP system by allowing the information or data to be collected electronically.

It is another object of the present invention to provide an improved ERP system that greatly reduces the time required to input data into the ERP system by allowing the data to be entered or inputted electronically.

It is a further object of the present invention to provide an improved ERP system that includes handheld data recording devices that are very easy to use and facilitate the increases in speed and reduction in errors of the improved ERP system.

It is still another object of the present invention to provide an improved ERP system that can continually provide updated information that is based upon information recently inputted into the system to the hand held devices employed by users of the system in addition to stationary data processing units.

The present invention is an improved ERP system that incorporates handheld computing devices that are used in place of prior art sheets and clipboards for the collection of data for the ERP system. The handheld devices greatly reduce the number and types of errors that can occur in the collection and entry of data for the ERP system, and provide the capability of virtually instantaneous transmission of this data to a control center including a server or computer on which the ERP system is located.

The handheld computing devices are capable of operably connecting with the computer on which the ERP system is located to both receive requests for information from the ERP system and to provide the information collected in response to the requests back to the ERP system. The information requests provided by the ERP system to the handheld device provide information to the worker about what type of information is necessary to be collected by the worker for submission to the ERP system. The worker can then collect this data by going to the appropriate locations within the facility at which the information can be obtained, and electronically entering the information into the handheld computing device, eliminating any handwriting and the errors associated therewith. The worker then can download the information to the ERP system without having to return to the location of the computer on which the ERP system is running. More specifically, the information for the requests and in response to the requests can be sent from the ERP system to the handheld computing device and from the device back to the ERP system through a physical or wire connection between the computer and handheld device, or by the transmission of wireless signals between the components. The physical connection between the handheld unit and the ERP system may be made by connecting the handheld device directly to the ERP system computer, or providing separate data transmission terminals connected to the ERP system throughout the facility in which the information is being collected. Thus, the improved ERP system provides the capability of virtually instantaneous transmission of the information collected by the worker on the handheld device from the device to the ERP system. Also, by providing multiple data transmission terminals or wireless connections, information can be simultaneously transmitted from multiple handheld devices directly to the ERP system without the data entry bottleneck experienced by prior art applications. This also allows the ERP system to provide continuous updates to the devices that include the information concerning the numerous aspects of the operation of the facility that has been entered into the ERP system.

Various other features, objects and advantages of the invention will be made apparent from the following detailed description taken together with the drawings.

### BRIEF DESCRIPTION OF THE DRAWINGS

The drawings illustrate the best mode presently contemplated of carrying out the invention.

In the drawings:

FIG. 1 is a schematic view of a facility in which the improved ERP system of the present invention is utilized;

FIG. 2 is a schematic view of the improved ERP system of the invention for use in a facility such as shown in FIG. 1;

FIG. 3 is a schematic view of a second embodiment of the improved ERP system of FIG. 1;

FIG. 4 is an isometric view of a handheld computing unit utilized with the improved ERP system of FIG. 1;

FIG. 5 is a flow chart of the administration program incorporated within the improved ERP system of FIG. 1; and

FIG. 6 is an operational flow chart of the operation of the improved ERP system of FIG. 1.

### DETAILED DESCRIPTION OF THE DRAWINGS

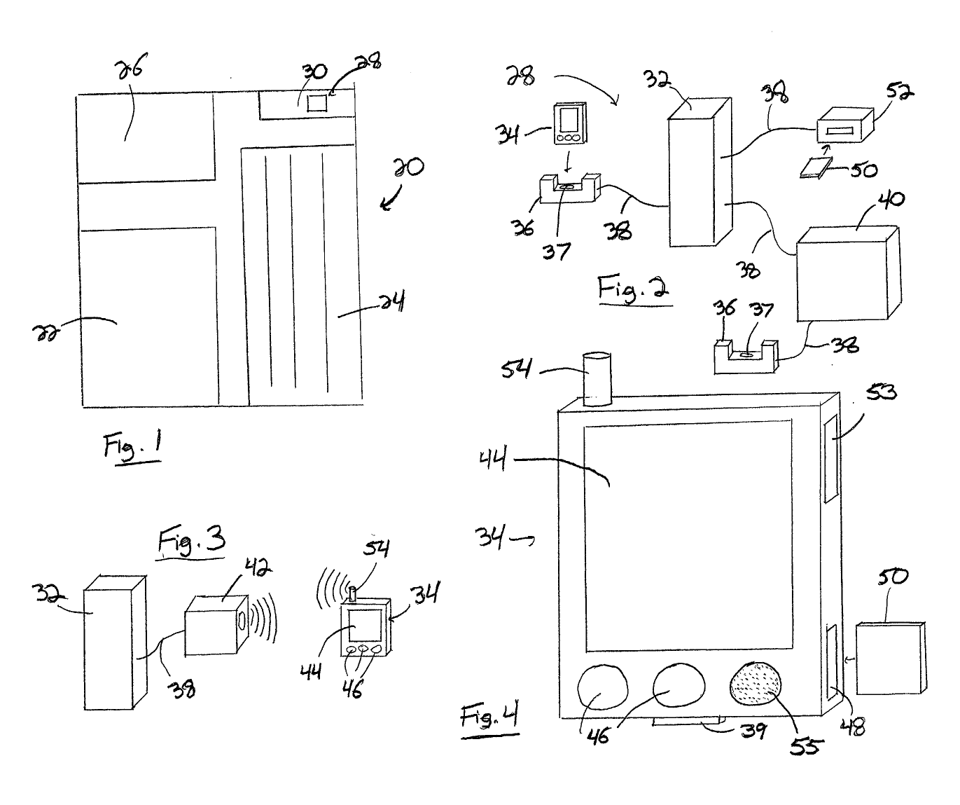

With reference now to the drawing figures in which like reference numerals designate like parts throughout the disclosure, a manufacturing and/or warehousing facility is illustrated generally at 20 in FIG. 1. The facility 20 includes a number of separate areas within the facility 20, such as a manufacturing area 22, a storage or inventory bin area 24, and a shipping/receiving area 26, among others. The various areas 22, 24 and 26 can be located near one another within a single facility 20, or may also be disposed in separate facilities 20, as necessary.

The facility 20 also includes an improved ERP system 28 located within the facility 20 that allows the operator of the facility 20 to effectively monitor the resource levels and internal operation of the facility 20. More specifically, the ERP system 28 is an accounting-oriented information system for identifying and planning the entire facility-wide resources needed to take, make, ship and account for customer orders submitted to the facility 20, which can be a manufacturing, distribution or service company, among others.

Referring now to FIGS. 1-4, the system 28 is preferably located in a central processing center 30 within the facility 20 which includes a server 32 on which the operating software for the ERP system 28 is loaded, and a number of handheld computing devices 34 that are connectable to the server 32. The operating software for the ERP system 28 can be any commercially available software package, such as M2M ERP sold by Made2Manage of Indianapolis, Ind., or TCM sold by WorkWise of Milwaukee, Wis., which is loaded onto the server 32 and modified by the propriety software CFJ HandHeld ERP sold by CFJ of Milwaukee, Wis., which enables the ERP software package to run on and/or interact with the devices 34 regardless of the type of ERP operating software being used. The server 32 can be any standard server or personal computer capable of processing and retaining the large amount of information provided to and utilized by the ERP system 28, such as a PowerEdge 600SC sold by Dell Computer Corporation, of Round Rock, Tex. The handheld devices 34 on which the data concerning the facility resources is entered are preferably conventional palmtop computers or personal digital assistants (PDA), such as the Compaq iPAQ 3835 sold by Hewlett-Packard of Palo Alto, Calif.

In a first embodiment of the system 28 shown in FIG. 2, the handheld devices 34 are connectable to the server 32 through the use of cradles 36. The cradles 36 are physically connected to the server 32 via a suitable data transmission cable 38 and include an interface port 37 capable of releasably connecting to a compatible interface plug 39 on the handheld device 34 in order to enable data communication between the device 34 and cradle 36, and the cradle 36 and server 32 through the cable 38. The cradles 36 can also be connected to a separate power source (not shown) in order to enable each cradle 36 to provide the additional function of a recharging station for the devices 34.

In an alternative embodiment also shown in FIG. 2, the server 32 is physically connected via cables 38 to a number of separate terminals 40 spaced about the interior of the facility 20 in the various facilities 20. The terminals 40 can be any suitable hardware platform for data transfer, from a complete personal computer to a simple data transfer connection station. The terminals 40 can have cradles 36 operably connected to the terminals 40 or incorporated in the terminals 40 themselves in order to transmit data received from the devices 34 via the cradles 36 through the terminals 40 and to the server 32. The terminals 40 can be spaced within or adjacent each of the areas 22, 24 and 26 of the facility 20 or in any other convenience-enhancing manner in order to limit the distance a worker has to travel within the facility 20 with the device 34 in order to connect to and transmit data to the server 32.

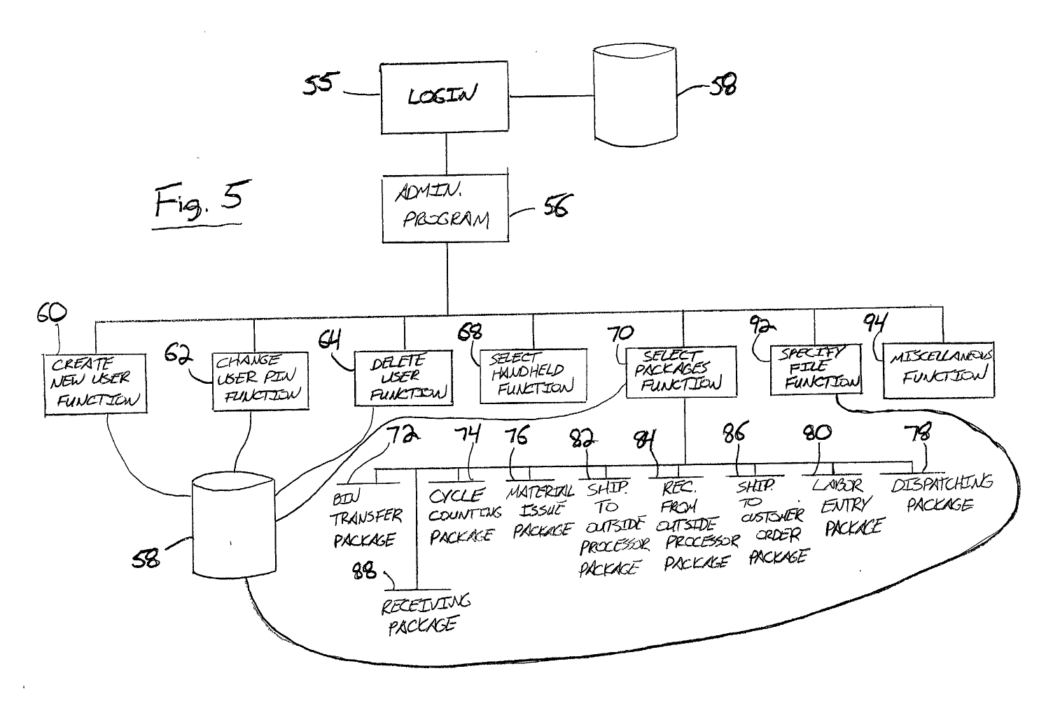

In still another preferred embodiment of the present invention schematically shown in FIG. 3, the facility 20 includes a number of receiver/transmitters 42 spaced throughout the facility 20. The receiver/transmitters 42, as is well known in the art, are capable of receiving wireless signals from the handheld devices 34 which are broadcast by the devices 34 as radio frequency signals or other wireless transmissions. The signals received by the receiver/transmitters 42 from the devices 34 can be forwarded as wireless signals from the receiver/transmitter 42 to the server 32 which is directly connected to a receiver/transmitter 42. Correspondingly, signals containing information from the server 32 can also be broadcast from the server 32 to the individual devices 34 through the various receiver/transmitters 42. Also, the receivers/transmitters 42 can be physically connected to the server 32 or to one or more terminals 40 by cables 38 to allow data to be transmitted between the receiver/transmitters 42 and the server 32.

The handheld devices 34, as best shown in FIG. 4, include a body 43 having a view screen 44 disposed in the center thereof and a number of control buttons 46 disposed beneath the screen 44. In order to increase the ease of entering data into the device 34, the screen 44 is preferably a touch screen, as is well known in the art. The screen 44 thus allows a worker to input information into the device 34 by touching various areas of the screen 44 with a finger or with another implement, such as a stylus (not shown). Information can also be entered using the buttons 46, which operate to move an icon on the screen 44 through the various items, panels or dropdown lists or menus displayed on the screen 44 and to enter data into a selected field or select an option on the dropdown menu provided on the screen 44. In the mode where the user selects items on the menus provided by the device 34, the problem of transposing numbers is effectively prevented.

The device 34 can also include a memory card slot 48 disposed on one side of the device 34 that is adapted to receive therein a memory card 50, such as a Compact Flash card, sold by SanDisk of Sunnyvale, Calif. In those embodiments of the system 28 where data is not transmitted via wireless signals, the memory card 50 can be used as a selectively rewritable information storage medium to transmit data between the device 34 and the server 32. More specifically, when the system 28 employs a memory card 50, the server 32 also includes a memory card reader 52 connected to the server 32 by a cable 38. A worker can place a memory card 50 within the card reader 52 when retrieving information from the server 32 and download and store that information from the server 32 on the card 50 using the reader 52. The card 50 is then removed from the reader 52 and inserted into the slot 48 on the device 34 in order to provide access to the information stored on the card 50 using the device 34. In addition to the information stored on the card 50 from the server 32, once the card 50 is engaged with the device 34, information inputted into the device 34 by the worker can also be stored on the memory card 50. Then, to transfer the worker-inputted data from the device 34 back to the server 32 for use by the ERP system 28, the card 50 is removed from the slot 48 in the device 34 and reinserted into the card reader 52. The server 32 can then retrieve the information inputted onto the device 34 using the reader 32 and utilized in operating the ERP system 28.

Also, to enable the device 34 to operate in the embodiment of the system 28 shown in FIG. 3 in which the device 34 and server 32 transmit information via wireless signals, the device 34 includes a receiver/transmitter antenna 54 on the body 43 of the device 34. The device 34 may still utilize the memory card 50 as a backup storage medium for the device 34, but any information stored on the card 50 is also transmitted through the receiver/transmitter antenna 54 to one of the receiver/transmitters 42 spaced around the facility 20.

Further, in this embodiment, to enable a worker to enter information into the device 34 without using the screen 44 or buttons 46, the device 34 can include a bar code scanner 53 that is capable of reading and retrieving information provided by bar codes (not shown) disposed on various items disposed within the different areas 22, 24 and 26 of the facility 20. For example, a worker can utilize the scanner 53 on the device 34 to scan a number of bar codes present on items that are stacked and ready to be shipped that are located at the shipping/receiving area 26. The information provided by the bar codes to the device 34 can then be transmitted to the server 32 in order to update the status of a particular order for which the scanned items are to be shipped. In a modification to this embodiment, the receiver/transmitter 51 and scanner 53 can be combined to provide a single, dual-purpose element on the device 34. Further, the scanner 53 can be used to verify that the user is at the proper location for obtaining the requested information. For example, when a user has selected a particular request item on the device 34, the user can employ the scanner 53 to scan a bar code on a bin, allowing the device 34 to compare the location specified in the request with the location identified by the bar code to ensure that the user is at the proper location.

The device 34 may also include a microphone 55 that is connected to a digital recording device (not shown) disposed within the device 34. The microphone 55 and recording device enable a user to dictate voice messages or notes onto the recording devices in association with a particular request to provide information about the request that cannot be otherwise entered into the device, e.g., if the item or items are present but broken. The voice messages can then be transmitted to the server 32 for review by an administrator in order to provide the voice messages to the administrator.

Having described the physical interaction of the components of the ERP system 28 with the facility 20 and with one another, the actual operation of the ERP system 28 will now be described. As best shown in FIG. 5, the system 28 provides various functions for an administrator or supervisor to be used in setting up the operating parameters of the system 28. In order to configure the system 28 to operate as desired, an administrator logs into the system 28 in box 55 using the server 32. The system 28 determines whether the person is a valid user and has access to the administration program 56 by accessing an administrator/user database 58 that contains the login information for each administrator to be granted access to the system 28. Once granted access, the administration program 58 allows the administrator to utilize seven separate functions to configure the system 28.

The first function available is the create new user function 60. When accessing this function 60, the administrator can input the name, a preselected identification code or username for the person, a personal identification number (PIN), and any other necessary information about a new user who is to be granted access to use the system 28.

The second function available is the change user PIN function 62. Under this function 62, the administrator can access the file that was created under function 60 for a particular user and change the PIN associated with that user. For example, if a PIN for a particular user has been misplaced, or if the PIN has been disclosed outside of the facility 20 to someone who is not an authorized user, the administrator can access the function 62 and determine the PIN for the user to either resupply the PIN to the user, or to delete the PIN entirely and provide the new PIN to the user.

A third function provided by the administration program 56 is the delete user function 64. This function 64 allows an administrator to access the system 28 and remove a file created for a particular user using the function 60 in its entirety. The function 64 is used in situations where, for example, an employee of the facility 20 terminates his or her employment, or is terminated, and it is necessary to prevent the user from being able to access the system 28 after termination, and to clear storage space for the addition of another user, if necessary. The user's login or username, PIN and other information contained in the file information are completely erased from the system 28 so that the particular user is no longer granted access the system 28.

Each of the create new user function 60, change user PIN function 62, and delete user function 64 are operably connected within the system 28 to the administrator/user database 58 within the system 28. The database 58 retains all of the information regarding each of the registered users of the system 28 so that this information can be created, modified and/or deleted by the administrator using one of the functions 60, 62 and 64, or for use by the system 28 when verifying the identity of an individual attempting to login to the system 28 as a registered user. Also, as discussed previously, the database 58 includes all relevant information regarding those users that are authorized to login to the system 28 as an administrator and access each of the functions provided under the administration program 56.

A fourth function provided by the administration program 56 is the select handheld model function 68. Under this function 68, depending upon the particular model or brand of handheld device 34 to be utilized with the system 28, the administrator can select a particular handheld model that is going to be used by all users with the system 28, or with regard to only a particular user in order to optimize the interaction of the system 28 with the device 34 based on any differences between various handheld device 34 models. Also, this function 68 can alternatively be accessed by a user when logging into the system 28 in order to enable the user to specify the type of handheld device 34 being used.

To further specify the amount of access of a particular user has to the system 28, the administration program 56 also provides an administrator with the select packages used function 70. Under this function 70, for each user in the user database 58, the administrator can identify, select and store in the database 58 particular system packages that the user will have access to when the user logs on to the system 28. The system packages from which the administrator can select include the bin transfer package 72, the cycle counting package 74, the material issue package 70, the dispatching package 78, the labor entry package 80, the shipping to an outside processor package 82, the receiving from an outside processor package 84, the shipping to a customer order package 86, and the receiving package 88. Based on the particular packages 72-88 selected by the administrator when using the function 70, the administrator can control the information that will be supplied to the user through the handheld device 34 when the user accesses the system 28. The selection of the particular packages 72-88 by the administrator in the function 70 is determined by the particular information that the administrator wishes the user to collect when logged onto the system 28. Each of the packages 72-88 deals with a separate aspect of the business of the facility 20, and requires a different type or types of information to be provided to the system 28 in order to update the resource information for the selected package 72-88.

The bin transfer package 72 allows a worker to utilize the handheld device 34 to input and/or record information regarding the particular location of items within the facility 20. More specifically, the bin transfer package 72 is an electronic record keeping method for maintaining an up-to-date listing of the locations and numbers of various items within bins or other storage locations found within the facility 20. The bin transfer package 73 initially provides the device 34 employed by the user with the last updated location and number of a particular item within the facility 20. The package 72 also provides the user with a second bin to which some or all of the items in the previously-identified location are to be transferred. The worker can then go to the identified initial bin, verify the location and number of the items in the bin, transfer an amount of the items contained within the bin to the second location specified by the package 72 and update the number of items remaining in the first bin. Thus, the bin transfer package 72 enables the system 28 to effectively monitor the location of various resources within the facility 20, such that, in situations where a particular part used in the operations of the facility 20 becomes low in a specified area, the system 28 can enable a worker to transfer an amount of the item to a storage bin near the location where the item has run low prior to the location running out of the particular item.

The cycle counting package 74 enables the system 28 to monitor the inventory of the facility 20 for each of the items contained in the inventory. More specifically, when a user accesses the cycle counting package 74, the system 28 downloads information to the handheld device 34 specifying particular storage locations or bins containing items for which the worker is to determine the actual number of items present within the bin. The package 74 may also supply the user with an expected number of items to be found within the bin based on previous inventory data supplied to the package 74. The worker then finds the appropriate bin and counts the number of items located within the bin. This number of items is then entered into the handheld device 34. This information is uploaded to and utilized by the system 28 to determine if the number of items entered into the system 28 is accurate based on other information stored within the system 28, such as the previous number of items located within the bin, and the number of items transferred from that bin pursuant to a request in the bin transfer package 72, if any items have been transferred.

The next package in the system 28 is the material issue package 76. This package 76 is used to monitor and control the inventory levels, schedules and availability of selective items, either manufactured or purchased, within the facility 20. When a user accesses the material issue package 76, the system 28 downloads a parts or items list to the handheld device 34 of the user that are to be pulled by the user and delivered to another area 22 or 24 of the facility 20 in preparing a work order. The user then goes out into the facility 20, pulls the parts listed on the handheld device 34 and inputs information into the device 34 regarding the parts that have been pulled. When this information is transferred or uploaded back to the system 28, the system 28 updates the package 76 to determine if any additional parts need to be issued for a particular work order or need to be ordered from a supplier of the item, as well as updating the other information in other packages within the system 28, such as the bin-transfer package 72 and the cycle counting package 74 due to the reduction in number of parts located within the appropriate storage bins.

Still another package available within the system 28 is the dispatching package 78. The dispatching package 78 controls the list of products to be sent out by the facility 20 that are either assembled or manufactured by workers within the facility 20 in response to work orders. A user having access to the dispatching package 78 receives a master list of the items to be dispatched by the facility 20 on his or her handheld device 34. The user then goes out to the appropriate area 22 or 26 of the facility 20 and checks the master list with the actual list for dispatching items located at the area. Any changes that have been made to the list, whether by addition or subtraction of various items to be dispatched, is then entered into the device 34 and uploaded to the system 28 to update the master list within the package 78. Furthermore, based on the adjustments made to the master list, the system 28 can also adjust the various dates for shipment of the items to be dispatched based on their movement within the master list, and the dates for receiving additional parts to replace those used in manufacturing or assembling dispatched items based on the movement of those items up or down on the master list.

Another package available within the system 28 is the labor entry package 80. A user having access to the labor entry package 80 is provided with information regarding the amount of time worked on a specific project by the user or any number of other users in order to determine the total amount of time spent on the completion of the project, whether the project be an assembled or manufactured item or the collection of data to be submitted to the system 28. The user can then update the time worked by entering the appropriate information onto the handheld device 34 so that this information can be uploaded to the system 28 upon completion of the shift of the user. The information supplied to the system 28 about the time spent working on the project by the user can then be manipulated by the system to determine a total overall time for the completion of the project, as well as to determine whether the amount of time was within specified parameters for the completion of the project. The labor entry package 80 takes the place of traditional labor entry systems, such as time sheets and punch clocks, each of which require further data entry for use in an electronic computing system such as an ERP system.

Still another package for that can be accessed is the shipping to an outside processor package 82. In situations where the facility 20 assembles or manufactures items which need to be processed outside of the facility 20, the shipping to an outside processor package 82 allows a user having access to the package 82 to download a list of information regarding items that are to be sent from the facility 20 to an outside processor for further treatment or adaptation. When the information list is downloaded from the system 28 to the user's handheld device 34 by the package 82, the user locates the appropriate items on the list supplied by the package 82 and enters information regarding the status of the shipment of the items to the outside processor into the device 34, i.e., whether the item is not ready for shipment, whether the item is ready for shipment, or whether the item has been shipped. This information is then uploaded to the system 28 for use in determining the return date of the item or items from the outside processors and the ultimate shipping date to the customer as determined by the return date. In doing so, the system 28 can monitor the performance of the outside processors in order to ensure that items are shipped to the customers on time, and without any unacceptable delays on the part of an outside processor.

To operate in conjunction with the shipping to an outside processor package 82, the system 28 also includes a receiving from an outside processor package 84. As stated previously, when items assembled or manufactured by the facility 20 are sent to an outside processor, the information regarding the date on which the item is shipped to the outside processor is recorded according to information supplied by the package 82. In the receiving from an outside processor package 84, the user downloads information from the system 28 to the handheld device 34 regarding items which are currently in the hands of outside processors. The user then takes this information to the shipping/receiving area 26 for the facility 20 and determines if any of the items found in the shipping/receiving area 26 correspond to the items found on the list supplied to the handheld device 34. If so, the user inputs information regarding those items on the list found at the shipping/receiving area 26 so that the system 28 can update the information regarding the item. The user may also input information regarding whether the item is to be further processed by the facility 20, or whether and, if so, when the item is to be stored for later use in finishing or assembling another item.

The final two packages to which a user can be provided access are the shipping package 86, and the receiving package 88. If a user is provided access to one or both of these packages 86 and 88, the system 28 downloads information to the user's handheld device 34 regarding items that are to be shipped from package 86, or items that are due to be received by the facility 20 from package 88. The user then goes to the shipping/receiving area 26 and determines the status for each of the items on the list, i.e., what items located in the area 26 are found on either the list for shipping or for receiving, what items have been shipped, and what items have not yet been received. The user then updates the information for each of the items on the list using the handheld device 34 and uploads this information to the system 28. Based on the information initially provided to the system 28 through the device 34, the system 28 can call for checks on orders that are ready to be shipped and waiting at the receiving area, orders that were to be assembled and brought to the receiving area 26 for shipment, and items which have been received at the facility 20 and are to be transferred to particular areas 22 or 24 within the facility 20.

When an administrator is determining which packages 72-88 to grant access to for a particular user, this information is stored within the database 58 within the system 28. Thus, when the database 58 is accessed each time a user accesses the system 28, the information regarding what packages 72-88 are available to the user can also be located in order to determine what information is to be provided to the user. Further, the information downloaded, retained and uploaded to the system 28 for each package 72-88 is stored within a package information database 90. This database 90 is utilized by the system 28 when a user has accessed and is using the system 28 in a manner to be described.

The administration program 56 also enables the administrator to further specify the information to be supplied to a user of the system 28 within a specific package 72-88 by utilizing the specify file location function 92. When using this function 92, if the administrator wishes to not only limit a user to information contained within a specific package 72-88, but also to restrict the user to specific information within this package, the administrator can specify a particular file or files on the system 28 within the specific package 72-88 in the database 58 for a user such that only these files are supplied to the user upon the user logging into the system 82. For example, if a user is being trained on the use of the system 28, the administrator can select only a small number of files in one or more of the packages 72-88 corresponding to specific work items to be downloaded. Thus, the user only receives a few tasks for completion from the system 28 to allow the user to become familiar with the operation of the system 28 and handheld device 34 without having to sift through a large amount of information downloaded from the system 28.

The seventh function provided by the administration program 56 is a miscellaneous function 94 which allows an administrator to control the operation of the administration program 56 in various ways, such as, for example, by changing the password for access to the program 56, or by modifying the preferences for the display of information by the system 28 on the device 34. Thus, the miscellaneous function 94 enables the administrator to alter the password or passwords which grant access to the administration program 56 for various reasons, including those specified with regard to the change user PIN function 62, and to modify the preferences for the system 28 to enable the administrator to control in a very detailed manner how information is presented to users of the system 28 to simplify the screens 44 and make the devices 34 easier to use. As is known in the art, the preferences for the system 28 are initially set to defaults which can only be altered by modifying the preferences using the miscellaneous function 94 in the administration program 56.

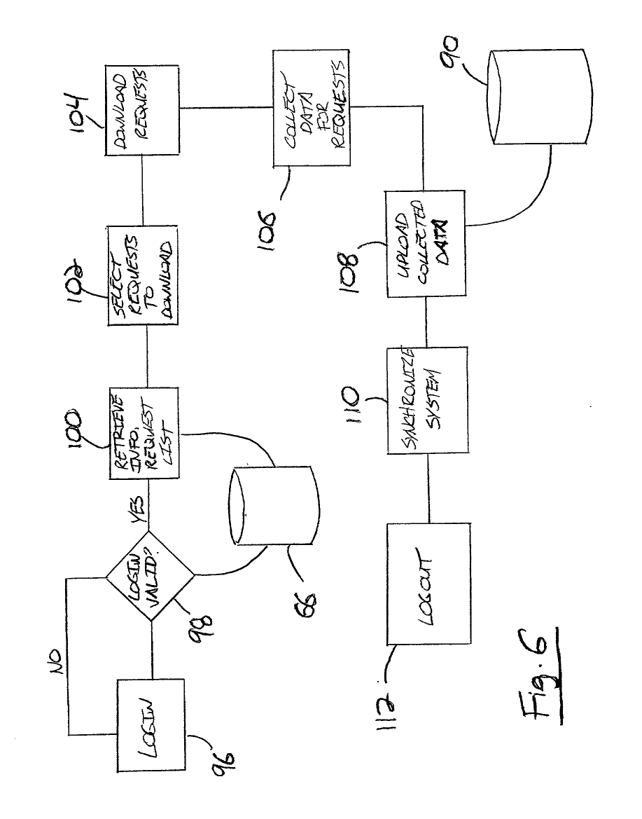

Referring now to FIG. 6, the process for use of the system 28 is illustrated. The user interaction with the system 28 is controlled in a manner specified by the administration program 56 that determines what operations can be performed on the handheld device 34 by a particular worker/user. Initially, in order to access the system 28, the user must login to the system 28 in block 96. When logging in, the user provides a user name and a PIN to the system 28. This information can be entered via the server 32, a terminal 40 or, in a preferred embodiment, can be entered directly on the screen 44 of the handheld device 34. At this point, the user can also specify with the login information the model for the device 34 that is being employed, as discussed previously.

The user enters the user name and PIN onto the device 34 and transmits this information to the system 28. The system 28 in decision block 98 then checks the user database 66 for the login information provided by the user. If the information is invalid, the system 28 directs the user back to the login prompt in block 96 to reenter the login information on the screen 44 of the handheld device 34.

However, if the login information is found within the administrator/user database 58, the system 28 proceeds to block 100 and accesses the file for the identified user in the database 58 and retrieves the preselected information requests to be provided to the user regarding the packages 72-88 specified in the user's file. Once the system 28 ascertains what packages 72-88 and what information requests within those packages 72-88 are to be provided to the user on the handheld device 34, the system 28 transmits to the device 34 a list of all the information requests available for download to the device 34 for the particular user. Depending upon what packages 72-88 the user is granted access to by the administrator, the information listed on the screen 44 of the device 34 can include information requests for one or more of the packages 72-88, as well as one or more particular information requests within each package 72-88.

To select the information requests which the user wishes to download from the system 28 to the device 34, in block 102 the user designates each package 72-88 and/or request on the list to be downloaded in any conventional manner, such as by highlighting the item, by checking a yes/no box disposed adjacent the particular item, or touching a button (not shown) on the screen 44 for the item, among others. The user can also use any of these methods to display the various items found under any package 72-88 by selecting that package 72-88, which lists the items in the package 72-88 available for download, and then can proceed to select individual items displayed in that list. Alternatively, the user can select all items within a package 72-88, such as by double clicking on that package 72-88. The system 28 also enables the user to de-select items by performing the same process for selecting items on items that have already been selected.

Once the user has selected all of the items to be downloaded, the user can initiate the download of the items to the device 34 in block 104 by selecting a download command located on the screen 44. The activation of this command transfers all of the information selected by the user from the package database 90 to the device 34 directly, or alternatively to the memory card 50 disposed in the card reader 52 that is attached to the server 32. If the user has made an error in downloading the information requests, the user can also select an erase command (not shown) on the device 34 or the server 32 to clear the downloaded information and begin again.

After the user has received all of the information downloaded from the server 32 to the handheld device 34, in block 106 the user can take the handheld device 34 and go to the appropriate area of the facility 20 in order to obtain the information required for completion of the downloaded information requests from each package 72-88, as described previously. To enter this information into the device 34 for a particular request, as stated previously, the user can employ the buttons 46 located on the body 36 of the device 34, or may use any other conventional means capable of use with the device 34, such as the user's finger, the stylus or a releasably attachable keyboard (not shown).

As the user collects the required data by entering the data into the device 34, the data can also be processed or manipulated on the device 34 by the user. This enables the user to obtain and process data for several requests without having to repeatedly connect the device 34 to the server 32 after collecting the data for a specific request so that the information can be transferred to and processed by the system 28 on the server 32. Further, because of the processing capability of the device 34, in the embodiment of the system 28 where the data is transmitted by wireless signals, the user can take the device 34 out of the wireless coverage area and still collect and process the collected data on the device 34. For example, the user can use the device 34 to sort or filter through the various requests downloaded to the device 34 in order to identify those requests associated with items disposed in a particular area of the facility 20. The user can then collect the information for each of these requests before proceeding to a different area. This maximizes the efficiency of the data collection by enabling the user to perform the data collection in a logical order, thereby preventing the user from having to go back and forth across the facility 20 to complete the requests in the order they are initially presented.

Next, after collecting and processing the information as necessary, in block 108 the user can upload the information from the device 34 to the server 32 for storage in the package information database 90 and use by the system 28. Depending upon the particular embodiment of the system 28, the information inputted into the device 34 by the user can be transmitted to the server 32 in a number of ways. If the device 34 is employing a memory card 50, the user must physically carry the device 34 and memory card 50 to a terminal 40 or to the server 32 in order to remove the memory card 50 from the device 34 and insert it within a reader 52 associated with the server 32 or terminal 40. However, if the information inputted by the user is stored directly within the device 34, this information can be supplied to the server 32 when the device 34 is placed within the cradle 36 connected to the server 32 or a terminal 40, or can be broadcast in a wireless signal directly from the device 34 to the receiver/transmitter 42 connected to the server 32.

Once the information is stored in the package information database 90, because this information will affect a number of other information requests being fulfilled by other users in block 110, the system 28 synchronizes the devices 34 by transmitting this updated information to each device 34 the next time the devices are connected to the server 32. For example, in those embodiments of the system 28 in which the devices 34 can transmit wireless signals to the server 32, as the information in response to the requests is entered into the system 28, this information is transmitted through the receiver/transmitters 42 from the server 32 to the remaining devices 34 to update the information in the requests on those devices 34, if necessary. Thus, in this embodiment the system 28 can process the information supplied by one or more devices 34 to the system 28 and synchronize or update the information provided to each device 34 virtually instantaneously. Thus, a user in the facility using a device 34 is constantly provided with up-to-date information regarding requests downloaded to the device 34 such that any errors in the collection of information on the device 34 due to the delay in entering information into the system 28 are eliminated. Further, if the embodiment of the system 28 is not capable of utilizing wireless signals transmitted to and from the server 32 and devices 34, the updating or synchronization of the information contained within the device 34 in block 110 is accomplished when the device 34 or memory card 50 is physically connected to the server 32. As a result, each device 34 or memory card 50 which is subsequently connected to the server 32 is provided with the updated information supplied by the server 32.

After all of the collected information has been uploaded to the server 32 from the device 34, or when the shift of the user is over, the user then logs out of the system in block 112, thereby allowing another user to login using the same device 34 to complete additional requests downloaded from the system 28.

While the system 28 has been described with regard to the interaction of the system 28 with a single device 34, the system 28 can support a number of individual users carrying separate handheld devices 34 at any one time. The devices 34 can simultaneously upload information to the system 28 through any of the aforementioned means, or may be simultaneously supplied with information downloaded from the system 28. The system 28 also enables the multiple devices 34 to synchronize with the server 32 and one another, as described previously. The system 28 also provides various record-keeping benefits not found in prior art systems. For example, because each of the devices 34 has an internal clock (not shown), each time the user operates the device 34 to login, download information, enter information, upload information, or logout, the device 34 can create date/time stamps when these activities are performed on the device 34 by a user. Further, in addition to the information requests and information that can be sent between the server 32 and a device 34, the system 28 is capable of transmitting emails and voice mails between the devices 34 via the server 32. This allows the requests and data to be accompanied by user-defined reminders, directions or cautions regarding the collection of data by a user using the devices 34. The system 28 can also be modified as necessary to include more or less information packages 72-88 in order to accommodate the operation of the particular facility 20 or industry in which the system 28 is used.

While the invention has been shown and described with respect to specific embodiments, it is understood that numerous variations and modifications are possible and contemplated as being within the scope of the present invention. For example, and without limitation, the specific packages and functions incorporated into the system may vary from those shown and described, and may be adapted or customized according to specific user requirements.

Various alternatives are contemplated as being within the scope of the following claims particularly pointing out and distinctly claiming the subject matter regarded as the invention.

We hereby claim:

1. A system for electronically monitoring the levels of and planning for the distribution of resources within a facility, the system comprising:
a) a data processing unit having a resource data storage means for storing data on the resources of the facility and a user data storage means for storing data on users of the system;
b) an enterprise resource planning program contained on the data processing unit; and
c) at least one handheld device capable of storing data within the at least one handheld device, processing data contained on the at least one handheld device, and receiving data electronically from and transmitting data electronically to the data processing unit and the at least one handheld device for use with the enterprise resource planning program.

2. The system of claim 1 further comprising at least one connection device operably connected to the data processing unit and releasably connectable to the at least one handheld device.

3. The system of claim 2 wherein the at least one connection device is further connected to a power source.

4. The system of claim 2 wherein the at least one connection device is a cradle that releasably and operably connects to the at least one handheld unit.

5. The system of claim 2 wherein the at least one handheld unit receives data from and transmits data to the data processing unit through the at least one connection device.

6. The system of claim 5 wherein the at least one connection device is connected to at least one terminal that is operably connected to the data processing unit.

7. The system of claim 1 wherein the at least one handheld unit transmits data to and receives data directly from the data processing unit.

8. The system of claim 7 further comprising a signal receiving/transmitting port on the at least one handheld unit capable of receiving and transmitting signals to and from the data processing unit.

9. The system of claim 1 wherein the at least one handheld unit includes a bar code scanning device.

10. The system of claim 1 wherein the at least one handheld unit is a palmtop computing device.

11. The system of claim 1 further comprising a memory card reader operably connected to the data processing unit and releasably connectable to a memory card insertable into the at least one handheld device.

12. The system of claim 11 wherein the at least one memory card reader is connected to at least one terminal that is operably connected to the data processing unit.

13. The system of claim 1 wherein the data includes voice messages.

14. A method for monitoring the level of and planning for the distribution of the resources of a facility, the method comprising the steps of:
a) providing a system including a data processing unit including a resource data storage means and a user data storage means, an enterprise resource planning program on the data processing unit, and at least one handheld computing unit capable of receiving data from and transmitting data to the data processing unit;
b) initializing the at least one handheld unit;
c) entering data into the at least one handheld unit; and
d) uploading the data from the at least one handheld unit to the data processing unit.

15. The method of claim 14 further comprising the step of synchronizing the at least one handheld unit and the data processing unit after initializing the at least one handheld unit.

16. The method of claim 14 wherein the step of initializing the at least one handheld unit comprises the steps of:
a) logging into the data processing unit; and
b) downloading data from the resource data storage means in the data processing unit to the at least one handheld unit.

17. The method of claim 16 wherein the step of logging into the data processing unit comprises the steps of:
a) operably connecting the at least one handheld unit to the data processing unit;
b) inputting identifying information into the at least one handheld unit; and
c) verifying the identifying information against user information located in the user data storage means.

18. The method of claim 16 wherein the step of downloading data further comprises the steps of:
a) selecting a program package from a list supplied to the at least one handheld unit by the data processing unit; and
b) initiating a download of the program package from the resource data storage means.

19. The method of claim 16 further comprising the step of selecting individual program package requests to be downloaded before initiating the download of the program package.

20. The method of claim 14 wherein the step of entering data into the at least one handheld unit comprises touching a screen on the at least one handheld unit.

21. The method of claim 14 wherein the step of entering data into the at least one handheld unit comprises scanning a bar code with the at least one handheld unit.

22. The method of claim 14 wherein the step of uploading data from the at least one handheld unit to the data processing unit further comprises the steps of:
a) operably connecting the at least one handheld unit to the data processing unit; and
b) selecting an upload function on the at least one handheld unit.

23. The method of claim 22 further comprising the step of deleting the data on the at least one handheld unit after selecting the upload function.

24. The method of claim 22 wherein the step of operably connecting the at least one handheld unit to the data processing unit comprises placing the at least one handheld unit in a cradle operably connected to the data processing unit.

25. The method of claim 22 wherein the step of operably connecting the at least one handheld unit to the data processing unit comprises the steps of:
a) removing a memory card from the at least one handheld unit; and
b) inserting the memory card into a memory card reader connected to the control center.

26. The method of claim 22 wherein the step of operably connecting the at least one handheld unit to the data processing unit comprises transmitting a wireless signal from the at least one handheld unit to the data processing unit.

27. The method of claim 16 wherein the step of downloading information from the resource data storage means to the at least one handheld unit comprises the steps of:
a) inserting a memory card into a memory card reader connected to the data processing unit;
b) downloading information from the resource data storage means in the data processing unit to the memory card; and
c) inserting the memory card into the at least one handheld unit.
